(19) United States
(12) Patent Application Publication
(10) Pub. No.: US 2025/0036988 A1
(43) Pub. Date: Jan. 30, 2025

(54) OPTIMAL QUANTUM FUNCTION IMPLEMENTATIONS BASED ON FUNCTION INPUTS

(71) Applicant: Classiq Technologies LTD., Tel Aviv (IL)

(72) Inventors: Amir Naveh, Haifa (IL); Shmuel Ur, Shorashim (IL); Nathaniel Rosenbloom, Tel Aviv-Yafo (IL); Peleg Emanuel, Tel Aviv (IL); Ravid Alon, Tel Aviv (IL); Ofek Kirzner, Haifa (IL); Yehuda Naveh, Tel-Aviv Yafo (IL)

(21) Appl. No.: 18/360,032

(22) Filed: Jul. 27, 2023

(51) Int. Cl. G06N 10/20; G06N 10/80

(52) U.S. Cl. CPC G06N 10/20; G06N 10/80

(57) ABSTRACT

Method, computer program products and apparatuses for preconditional implementation swaps between quantum functions in order to improving a target optimization metric when executing the modified quantum circuit. A quantum circuit comprising a quantum function configured to receive input qubits and perform a manipulation thereon is obtained with input conditions on at least a portion of the input qubits, that are guaranteed to be met when the quantum function is utilized by the quantum circuit. A set of equivalent quantum functions that are equivalent to the quantum function under the input conditions is determined, such as using an equivalences graph representing equivalent functions under various input conditions. An optimized quantum function is selected from the set based on a target optimization metric. A modified improved quantum circuit is generated by replacing the quantum function with the optimized quantum function.

### TECHNICAL FIELD

The present disclosure relates to quantum computing in general, and to implementing quantum functions in accordance with conditions on inputs, in particular.

### BACKGROUND

Quantum computing has become a promising field due to its potential for solving complex problems that are intractable for classical computers. However, the implementation of quantum functions, which are the building blocks of quantum algorithms, can be challenging due to their inherent complexity and susceptibility to noise.

While there are many different quantum circuits that can implement the same quantum function, some circuits may be more efficient than others in terms of resource usage, speed, and error rate. Therefore, finding an efficient implementation of quantum functions is critical for the development of powerful quantum algorithms.

The development of such implementations has potential applications in a wide range of fields, including cryptography, machine learning, and optimization. The study of equivalent quantum functions allows researchers to explore different ways of implementing a quantum function to find the most efficient circuit.

### BRIEF SUMMARY

One exemplary embodiment of the disclosed subject matter is a method comprising: obtaining a representation of a quantum circuit, the quantum circuit manipulates a plurality of qubits over a plurality of cycles using a plurality of quantum gates, the representation of the quantum circuit comprises a representation of a quantum function configured to be utilized in the quantum circuit, wherein the quantum function is configured to receive one or more input qubits and perform a manipulation on the one or more input qubits; obtaining one or more input conditions on at least a portion of the one or more input qubits, the one or more input conditions are guaranteed to be met when the quantum function is utilized by the quantum circuit; determining a set of one or more equivalent quantum functions that are equivalent to the quantum function under the one or more input conditions, wherein said determining is performed using an equivalences graph representing equivalent functions under various input conditions, wherein each node of the equivalences graph represents a function acting on an ordered list of qubits, wherein each directed edge is associated with a condition on one qubit of the ordered list of qubits, wherein a directed edge connects between a first node and a second node if under the condition associated with the directed edge an output of the second function is equivalent to an output of the first function, wherein the equivalences graph comprises at least one unitary node that represents a unitary function, and at least one non-unitary node that represents a non-unitary function, wherein said determining the set of equivalent quantum functions comprises: determining a set of nodes of the equivalences graph that represent functions that are equivalent to the quantum function in view of the one or more input conditions, wherein said determining the set of nodes comprises traversing nodes, starting from a node representing the quantum function, through directed edges that are associated with conditions that are held by the one or more input conditions; and wherein the set of equivalent quantum functions comprises unitary functions included in the set of nodes; selecting an optimized quantum function from the set of equivalent quantum functions, wherein said selecting is performed based on a target optimization metric; and generating a modified quantum circuit by replacing the quantum function with the optimized quantum function, whereby improving the target optimization metric when executing the modified quantum circuit compared to an execution of a different version of quantum circuit that uses the quantum function.

Optionally, the set of nodes comprises a non-unitary node, wherein the set of equivalent quantum functions excludes the non-unitary function associated with the non-unitary node.

Optionally, said determining the set of nodes comprises: a forward cone of influence traversal over edges that hold the one or more input conditions to determine a first set of nodes; and a backward cone of influence traversal from the first set of nodes over edges that hold the one or more inputs conditions to determine a second set of nodes; wherein the set of nodes include the first set of nodes and the second set of nodes.

Optionally, the first set of nodes comprises a non-unitary node, wherein the second set of nodes comprises a unitary node that is an ancestor of the non-unitary node, wherein the unitary node is included in the second set of nodes based on a connection between the non-unitary node and the unitary node.

Optionally, the set of equivalent quantum functions includes the quantum function, whereby said selecting the optimized quantum function enables selecting to avoid modifying the quantum circuit.

Optionally, the set of equivalent quantum functions include a first quantum function and a second quantum function having a first set of input qubits and a second set of input qubits respectively, a number of qubits in the first set of input qubits is smaller than a number of qubits in the second set of input qubits, wherein the second quantum function is selected as the optimized quantum function in spite of having a larger number of input qubits.

Optionally, said obtaining the one or more input conditions comprises analyzing the representation of the quantum circuit to determine pre-conditions that are enforced by the quantum circuit over at least a portion of the one or more input qubits.

Optionally the method further comprises generating the equivalences graph, wherein said generating is performed offline and prior to having access to the representation of the quantum circuit, whereby the equivalences graph is usable with respect to a plurality of different quantum circuits.

Optionally the method further comprises executing the modified quantum circuit on a quantum execution platform.

Optionally, said selecting the optimized quantum function is performed based on hardware characteristics of a quantum execution platform that is designated to execute the quantum circuit.

Optionally, the one or more input conditions on at least a portion of the one or more input qubits comprises an input condition on an input qubit, the input condition indicating that a value of the input qubit is constant.

Optionally, the one or more input conditions on at least a portion of the one or more input qubits comprises an input condition on an input qubit, the input condition indicating that a value of the input qubit is zeros, wherein the input qubit is utilized in the quantum function as an auxiliary qubit.

Optionally, the representation of the quantum circuit is a quantum program provided programmed in a high-level programming language, wherein the quantum program defines quantum functions used in the quantum circuit, partial order therebetween, and information passing between the quantum functions.

Optionally, said obtaining the one or more input conditions and said selecting the optimized quantum function are performed by a quantum compiler that compiles the quantum program into a gate-level quantum circuit.

Optionally, the one or more input conditions are derived from the quantum program or instructions provided with the quantum program, whereby the quantum program or the instruction provided therewith guarantee that the one or more input conditions are met when the quantum function is utilized by the quantum circuit.

Optionally, the representation of the quantum circuit is a Directed Acyclic Graph (DAG), a node in the DAG represents a quantum function, wherein an edge in the DAG between a first node and a second node of the DAG represents a qubit that is utilized as an output qubit in a function represented by the first node and as an input qubit in a function represented by the second node.

Optionally, the set of equivalent quantum functions consists of all unitary functions included in the set of nodes.

Another exemplary embodiment of the disclosed subject matter is a method for modifying a quantum circuit, comprising: obtaining the quantum circuit, the quantum circuit manipulates a plurality of qubits over a plurality of cycles using a plurality of quantum gates, the quantum circuit comprises a quantum function, wherein the quantum function is configured to receive one or more input qubits and perform a manipulation on the one or more input qubits; obtaining one or more input conditions on at least a portion of the one or more input qubits, the one or more input conditions are guaranteed to be met when the quantum function is utilized by the quantum circuit; determining a set of one or more equivalent quantum functions that are equivalent to the quantum function under the one or more input conditions, wherein said determining is performed using an equivalences graph representing equivalent functions under various input conditions, wherein each node of the equivalences graph represents a function acting on an ordered list of qubits, wherein each directed edge is associated with a condition on one qubit of the ordered list of qubits, wherein a directed edge connects between a first node and a second node if under the condition associated with the directed edge an output of the second function is equivalent to an output of the first function, wherein the equivalences graph comprises at least one unitary node that represents a unitary function, and at least one non-unitary node that represents a non-unitary function, wherein said determining the set of equivalent quantum functions comprises: determining a set of nodes of the equivalences graph that represent functions that are equivalent to the quantum function in view of the one or more input conditions, wherein said determining the set of nodes comprises traversing nodes, starting from a node representing the quantum function, through directed edges that are associated with conditions that are held by the one or more input conditions; and wherein the set of equivalent quantum functions comprises unitary functions included in the set of nodes; selecting an optimized quantum function from the set of equivalent quantum functions, wherein said selecting is performed based on a target optimization metric; and modifying the quantum circuit by replacing the quantum function with the optimized quantum function, whereby improving the target optimization metric when executing the modified quantum circuit compared to an execution of the quantum circuit.

Optionally, the quantum circuit is a pre-existing quantum circuit that was synthesized by a compiler.

Yet another exemplary embodiment of the disclosed subject matter is a computerized apparatus having a processor, the processor being adapted to perform the steps of: obtaining a representation of a quantum circuit, the quantum circuit manipulates a plurality of qubits over a plurality of cycles using a plurality of quantum gates, the representation of the quantum circuit comprises a representation of a quantum function configured to be utilized in the quantum circuit, wherein the quantum function is configured to receive one or more input qubits and perform a manipulation on the one or more input qubits; obtaining one or more input conditions on at least a portion of the one or more input qubits, the one or more input conditions are guaranteed to be met when the quantum function is utilized by the quantum circuit; determining a set of one or more equivalent quantum functions that are equivalent to the quantum function under the one or more input conditions, wherein said determining is performed using an equivalences graph representing equivalent functions under various input conditions, wherein each node of the equivalences graph represents a function acting on an ordered list of qubits, wherein each directed edge is associated with a condition on one qubit of the ordered list of qubits, wherein a directed edge connects between a first node and a second node if under the condition associated with the directed edge an output of the second function is equivalent to an output of the first function, wherein the equivalences graph comprises at least one unitary node that represents a unitary function, and at least one non-unitary node that represents a non-unitary function, wherein said determining the set of equivalent quantum functions comprises: determining a set of nodes of the equivalences graph that represent functions that are equivalent to the quantum function in view of the one or more input conditions, wherein said determining the set of nodes comprises traversing nodes, starting from a node representing the quantum function, through directed edges that are associated with conditions that are held by the one or more input conditions; and wherein the set of equivalent quantum functions comprises unitary functions included in the set of nodes; selecting an optimized quantum function from the set of equivalent quantum functions, wherein said selecting is performed based on a target optimization metric; and generating a modified quantum circuit by replacing the quantum function with the optimized quantum function, whereby improving the target optimization metric when executing the modified quantum circuit compared to an execution of a different version of quantum circuit that uses the quantum function.

Yet another exemplary embodiment of the disclosed subject matter is a computer program product comprising a non-transitory computer readable storage medium retaining program instruction, which program instructions when read by a processor, cause the processor to perform a method comprising: obtaining a representation of a quantum circuit, the quantum circuit manipulates a plurality of qubits over a plurality of cycles using a plurality of quantum gates, the representation of the quantum circuit comprises a representation of a quantum function configured to be utilized in the quantum circuit, wherein the quantum function is configured to receive one or more input qubits and perform a manipulation on the one or more input qubits; obtaining one or more input conditions on at least a portion of the one or more input qubits, the one or more input conditions are guaranteed to be met when the quantum function is utilized by the quantum circuit; determining a set of one or more equivalent quantum functions that are equivalent to the quantum function under the one or more input conditions, wherein said determining is performed using an equivalences graph representing equivalent functions under various input conditions, wherein each node of the equivalences graph represents a function acting on an ordered list of qubits, wherein each directed edge is associated with a condition on one qubit of the ordered list of qubits, wherein a directed edge connects between a first node and a second node if under the condition associated with the directed edge an output of the second function is equivalent to an output of the first function, wherein the equivalences graph comprises at least one unitary node that represents a unitary function, and at least one non-unitary node that represents a non-unitary function, wherein said determining the set of equivalent quantum functions comprises: determining a set of nodes of the equivalences graph that represent functions that are equivalent to the quantum function in view of the one or more input conditions, wherein said determining the set of nodes comprises traversing nodes, starting from a node representing the quantum function, through directed edges that are associated with conditions that are held by the one or more input conditions; and wherein the set of equivalent quantum functions comprises unitary functions included in the set of nodes; selecting an optimized quantum function from the set of equivalent quantum functions, wherein said selecting is performed based on a target optimization metric; and generating a modified quantum circuit by replacing the quantum function with the optimized quantum function, whereby improving the target optimization metric when executing the modified quantum circuit compared to an execution of a different version of quantum circuit that uses the quantum function.

Yet another exemplary embodiment of the disclosed subject matter is a computerized apparatus having a processor, the processor being adapted to perform the steps of: obtaining the quantum circuit, the quantum circuit manipulates a plurality of qubits over a plurality of cycles using a plurality of quantum gates, the quantum circuit comprises a quantum function, wherein the quantum function is configured to receive one or more input qubits and perform a manipulation on the one or more input qubits; obtaining one or more input conditions on at least a portion of the one or more input qubits, the one or more input conditions are guaranteed to be met when the quantum function is utilized by the quantum circuit; determining a set of one or more equivalent quantum functions that are equivalent to the quantum function under the one or more input conditions, wherein said determining is performed using an equivalences graph representing equivalent functions under various input conditions, wherein each node of the equivalences graph represents a function acting on an ordered list of qubits, wherein each directed edge is associated with a condition on one qubit of the ordered list of qubits, wherein a directed edge connects between a first node and a second node if under the condition associated with the directed edge an output of the second function is equivalent to an output of the first function, wherein the equivalences graph comprises at least one unitary node that represents a unitary function, and at least one non-unitary node that represents a non-unitary function, wherein said determining the set of equivalent quantum functions comprises: determining a set of nodes of the equivalences graph that represent functions that are equivalent to the quantum function in view of the one or more input conditions, wherein said determining the set of nodes comprises traversing nodes, starting from a node representing the quantum function, through directed edges that are associated with conditions that are held by the one or more input conditions; and wherein the set of equivalent quantum functions comprises unitary functions included in the set of nodes; selecting an optimized quantum function from the set of equivalent quantum functions, wherein said selecting is performed based on a target optimization metric; and modifying the quantum circuit by replacing the quantum function with the optimized quantum function, whereby improving the target optimization metric when executing the modified quantum circuit compared to an execution of the quantum circuit.

Yet another exemplary embodiment of the disclosed subject matter is a computer program product comprising a non-transitory computer readable storage medium retaining program instruction, which program instructions when read by a processor, cause the processor to perform a method comprising: obtaining the quantum circuit, the quantum circuit manipulates a plurality of qubits over a plurality of cycles using a plurality of quantum gates, the quantum circuit comprises a quantum function, wherein the quantum function is configured to receive one or more input qubits and perform a manipulation on the one or more input qubits; obtaining one or more input conditions on at least a portion of the one or more input qubits, the one or more input conditions are guaranteed to be met when the quantum function is utilized by the quantum circuit; determining a set of one or more equivalent quantum functions that are equivalent to the quantum function under the one or more input conditions, wherein said determining is performed using an equivalences graph representing equivalent functions under various input conditions, wherein each node of the equivalences graph represents a function acting on an ordered list of qubits, wherein each directed edge is associated with a condition on one qubit of the ordered list of qubits, wherein a directed edge connects between a first node and a second node if under the condition associated with the directed edge an output of the second function is equivalent to an output of the first function, wherein the equivalences graph comprises at least one unitary node that represents a unitary function, and at least one non-unitary node that represents a non-unitary function, wherein said determining the set of equivalent quantum functions comprises: determining a set of nodes of the equivalences graph that represent functions that are equivalent to the quantum function in view of the one or more input conditions, wherein said determining the set of nodes comprises traversing nodes, starting from a node representing the quantum function, through directed edges that are associated with conditions that are held by the one or more input conditions; and wherein the set of equivalent quantum functions comprises unitary functions included in the set of nodes; selecting an optimized quantum function from the set of equivalent quantum functions, wherein said selecting is performed based on a target optimization metric; and modifying the quantum circuit by replacing the quantum function with the optimized quantum function, whereby improving the target optimization metric when executing the modified quantum circuit compared to an execution of the quantum circuit.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A-1B shows a flowchart diagram of a method, in accordance with some exemplary embodiments of the disclosed subject matter;

FIG. 2 shows a set of nodes of an exemplary equivalences graph, in accordance with some exemplary embodiments of the subject matter; and

FIG. 3 shows a block diagram of an apparatus, in accordance with some exemplary embodiments of the disclosed subject matter.

### DETAILED DESCRIPTION

One technical problem dealt with by the disclosed subject matter is to enhance a performance of a quantum program, by optimizing the quantum circuits utilized for their implementation.

While quantum computing has the potential to revolutionize many areas of science and technology, the implementation of quantum algorithms is currently limited by the available resources and the difficulty of controlling and correcting errors. One significant issue is that there can be different circuit designs that implement the same quantum function. Since different circuit designs can implement the same quantum function, some designs may be more efficient than others in terms of gate counts, error rates, or any other target metric. One way to address this problem is to optimize the circuits by using more efficient quantum functions. In some cases, the optimization may take into account the target hardware that will execute the circuit. However, finding such functions can be challenging, especially when there are many different circuits that can implement the same function. Therefore, there is a need for methods and systems for identifying equivalent quantum circuits that can be implemented using different circuit designs, where some designs may be more efficient than others.

In quantum computing, a quantum function is a unitary operation that acts on one or more qubits. A unitary operator may be a surjective bounded operator on a Hilbert space that preserves the inner product. Unitary operations may be taken as operating on a Hilbert space, but the same notion serves to define the concept of isomorphism between Hilbert spaces. As an example, a unitary operator U may be a bounded linear operator U:H→H on a Hilbert space H that satisfies U*U=UU*=I, where U* is the adjoint of U, and I:H→H is the identity operator. It is noted that any quantum function must be a whole-space quantum function, and cannot be a subspace quantum function, as subspace quantum functions are not unitary functions. Whole-space quantum functions are functions that can be applied to any input state, e.g., act on the entire state space of the possible inputs, (“function-domain”). Whole-space functions are often used as building blocks for more complex quantum algorithms.

On the other hand, subspace quantum functions are those that only act on a subset of the state space of its input qubits. These functions are characterized by a property of their input, which is used to restrict the input space to a specific subspace of the space. Only whole-space functions can be used in an actual quantum circuit, since a unitary matrix transforms an arbitrary vector of qubits of the proper length. The output may be undefined if a subspace function receives a value outside of the function's domain. By restricting the input space, subspace functions can be more easily implemented and optimized than whole-space functions. The subspace functions can be used in a high-level circuit, and can be replaced by whole-space ones during a circuit synthesis process, during compilation, during circuit modification, or the like. Using subspace functions when modeling the quantum circuit at a high level enables selecting an optimized concrete implementation. Even if the user does not explicitly provide a subspace function, such function may be inferred based on the behavior of the function given conditions or restrictions on the input, and define the sup-space accordingly.

One technical solution is to optimize the quantum circuits by replacing less efficient quantum functions with equivalent, more efficient ones. The replacement, or “swapping” between the two functions, may be performed based on identification of conditions under which two quantum functions behave identically. The optimization may be achieved in compilation phase, by swapping between different implementations of functions (e.g., replace the less efficient implementation with a more efficient implementation) that provide the same output (e.g., equivalent) given a preconditioned input, in a manner optimizing the implementation goals.

It is noted that the selection may also depend on a target quantum computer, as different hardware may behave differently for the same quantum circuit in view of hardware restrictions, while attempting to preserve logical consistency with the circuit. Accordingly, executing the same circuit on different hardware may yield different error rates, different utilization of quantum resources (e.g., cost per gate, number of gates utilized, etc.).

In some exemplary embodiments, the conditions under which the two quantum functions behave identically may be guaranteed to be met because of logical composition of the quantum program representing the quantum circuit, based on known constraints or values of the input of the quantum program, or the like. In some cases, the quantum circuit may be represented as a quantum program provided, by a user, a programmer, or the like, to a compiler in a high-level programming language. The quantum program may define quantum functions used in the quantum circuit, partial order therebetween, and information passing between the quantum functions. In some cases, the user may provide the input conditions explicitly, such as by providing a value of a certain parameter of the function, providing a restriction on values of parameters, or the like. As an example, the quantum program may comprise the instruction ADD (Y,0,Z). Such instruction may mean that the ADD quantum function is performed using Y and Z qubits and while providing the zero value to the second parameter of the function. Such condition on the input is provided directly by the programmer, identified automatically by the compiler during the compilation process, or the like. The set of equivalent functions may comprise under this condition, a simpler function, with only two parameters, disregarding the value of the second parameter, such as ADD(Y,Z) or any other equivalent function with the same number of parameters, or even more parameters (e.g., F2(Y,Z,0,0)). As another example, a value of a parameter of the function may be set in the compilation process due to restrictions from earlier instructions of functions of the quantum program, such as an instruction to substitute the value 0 in the second parameter.

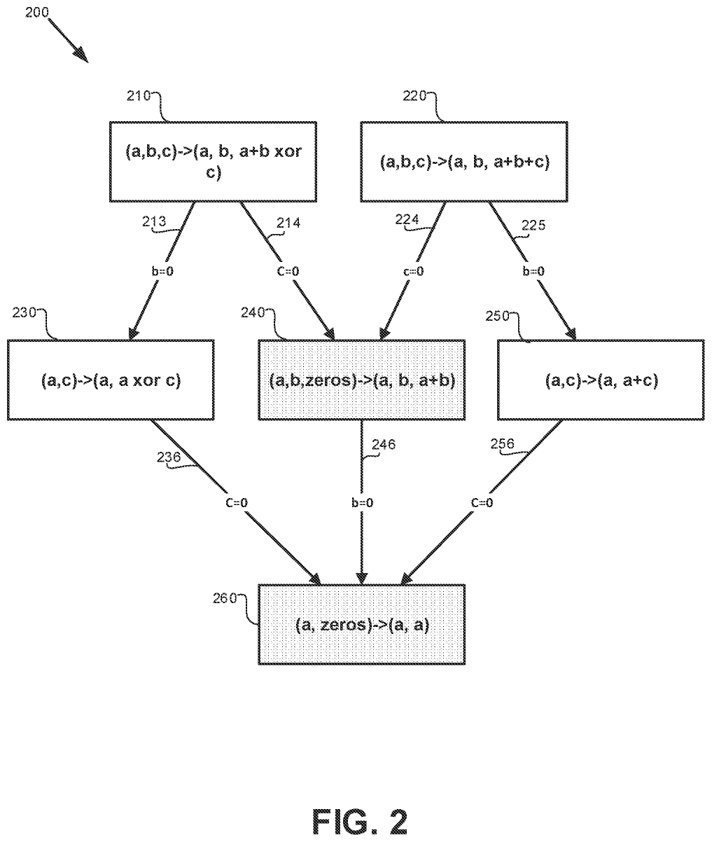

Additionally, or alternatively, an offline analysis may be performed to identify under which conditions two quantum functions provide identical outputs. The analysis may be performed by comparing transformations that correspond to quantum circuits implementing equivalent quantum functions. The transformations may be mathematical representations of the quantum circuits that describe the time evolution of the quantum states. By comparing the transformations, it is possible to identify equivalent quantum circuits that implement the same quantum function. The information may then be utilized to replace one function with a more efficient equivalent function, during runtime. By storing or calculating information about which functions are equivalent under various input conditions, the invention allows for the efficient optimization of quantum circuits. By storing or calculating information about which functions are equivalent under various input conditions, the invention allows for the efficient optimization of quantum circuits. Such information may be calculated and stored as a set of rules defining equivalency of functions under certain conditions, e.g., rules defining two or more quantum functions that are equivalent under the one or more input conditions. As an example, the rule may be: “In a case that the second parameter of F(X, Y, Z) is 0, the function F can be replaced by F1(X, Z)”. The set of rules may be an alternative implicit representation of an equivalences graph, as described further herein below, as opposed to an explicit graph representation, such as visually illustrated in FIG. 2. In some exemplary embodiments, the set of equivalent quantum functions that are equivalent to a certain quantum function under certain input conditions may be calculated in advanced, stored in a data structure accessible during the compilation process or the circuit synthesis process, or the like. Additionally, or alternatively, the set of equivalent quantum functions that are equivalent to a certain quantum function under one or more input conditions may be calculated on the fly, during the compilation process, or the like, whenever a certain input condition applies.

In some exemplary embodiments, the selection of the equivalent quantum functions may be according to a target optimization metric, such as a specific criterion or objective chosen based on the goals and requirements of the specific quantum computation or application. As an example, the selection may be performed based on the hardware characteristics of the quantum execution platform on which the quantum circuit will be executed. It is noted that the selection of the optimized quantum function is not solely based on the number of input qubits of the quantum circuit. The set of equivalent quantum functions may include different options with varying numbers of input qubits. In some cases, a quantum function with a larger number of input qubits may still be selected as the optimized quantum function, despite having more qubits to initialize and manipulate.

In some cases, the selection of the desired quantum function to be utilized may be made using a pre-prepared designated data structure, such as a data structure being prepared during the offline analysis phase, that can be utilized to identify equivalent functions during compilation, during circuit synthesis, during circuit modification, or the like. Additionally, or alternatively, other representations of the pre-condition equivalent functions may be utilized, such as in a rule-based approach. In some exemplary embodiments, an equivalences graph may be utilized. The equivalences graph may represent equivalent functions that provide the same output under various input conditions. A node in the equivalences graph may represent a function acting on a set of qubits having an order, e.g., an ordered list of qubits. Some nodes may represent unitary functions, and be referred to as unitary nodes. In some cases, the graph may include one or more non-unitary nodes that represent non-unitary functions, such as subspace quantum functions. Directed edges may represent equivalences between functions given a pre-defined condition (which may be, e.g., indicated in the label of the edge). A directed edge connects between a first node and a second node if under the condition associated with the directed edge an output of the second function is equivalent to an output of the first function.

In some cases, the graph may be utilized, at runtime, to identify all equivalent unitary functions to a function that is used in the quantum circuit, given determined preconditions that are relevant for the quantum circuit. The set of all equivalent unitary functions may be identified based on the directed edges in the graph. In some cases, an initial node that represents the original quantum function used in the quantum circuit may be identified. Graph traversal may commence from the initial node and traverse all directed edges for which the associated condition is held, to identify additional equivalent nodes. In some cases, traversing against the direction of the edge may also be possible, as long as the condition is still held. In some cases, non-unitary nodes that are traversed may not represent unitary functions and therefore they may be serve as intermediate nodes that are used to enable the identification of the equivalent unitary functions that can be achieved by applying conditions on the qubits utilized thereby.

One technical effect of the disclosed subject may be improving efficiency, providing faster computations, and reduced error rates, in implementation of quantum algorithms. All of which have significant implications for the development of quantum algorithms and their applications in various fields. The optimization process takes into account various constraints, such as the available hardware resources, the error rates of the quantum gates, and the required accuracy of the computation. The invention enables the efficient implementation of quantum circuits, which can lead to significant improvements in the performance and scalability of quantum computers.

Another technical effect of utilizing the disclosed subject matter is to select an implementation of a function that reduces the amount of resources, such as qubits or time resources, that are utilized, while being equivalent to other implementations. In some exemplary embodiments, the implementation of a function may be selected according to optimization criteria.

Yet another technical effect of utilizing the disclosed subject matter is to re-use computational and time resources utilized for constructing a function library for different quantum circuits, enabling overall reduction of required resources to generate a plurality of quantum circuits over time.

The disclosed subject matter may provide for one or more technical improvements over any pre-existing technique and any technique that has previously become routine or conventional in the art. Additional technical problems, solutions, and effects may be apparent to a person of ordinary skill in the art in view of the present disclosure.

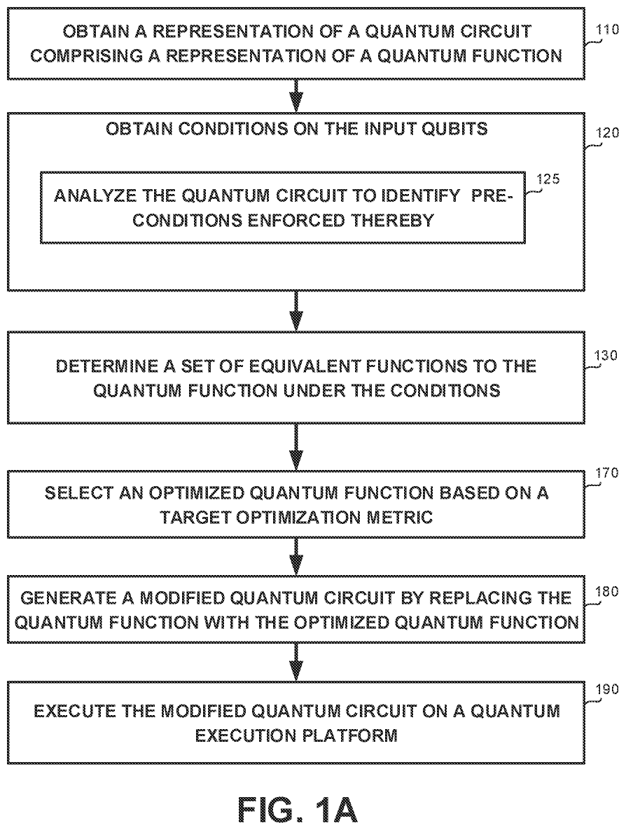

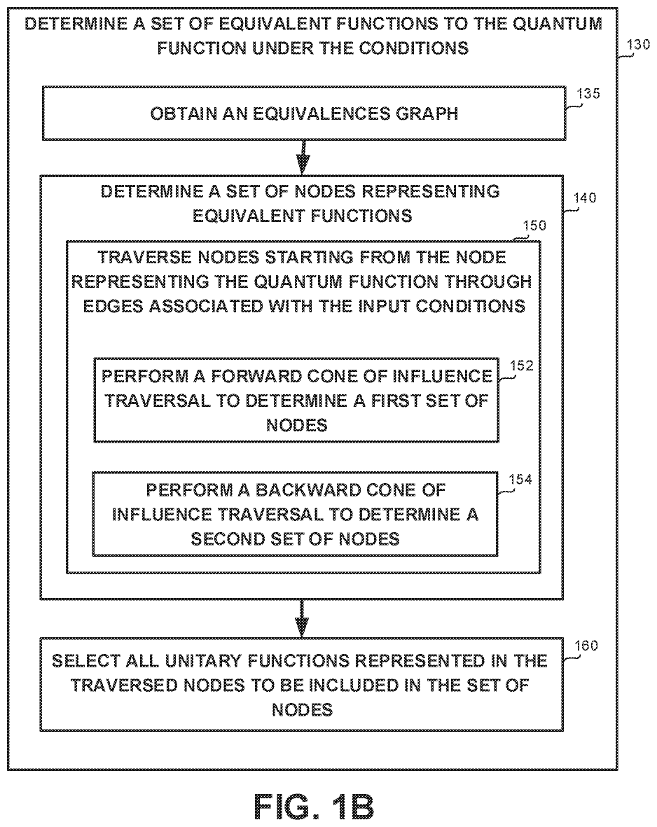

Referring now to FIGS. 1A-1B showing a flowchart diagram of a method, in accordance with some exemplary embodiments of the disclosed subject matter. FIG. 1B shows sub-steps included in Step 130 of FIG. 1A.

On Step 110, a representation of a quantum circuit may be obtained. The quantum circuit may be configured to manipulate a plurality of qubits over a plurality of cycles using a plurality of quantum gates. The representation of the quantum circuit may be obtained in functional-level, in gate-level, or the like. In some exemplary embodiments, the representation of the quantum circuit may be provided in a high-level programming language. The quantum program may define quantum functions used in the quantum circuit, partial order therebetween, and information passing between the quantum functions. The representation of the quantum circuit may be provided in a similar manner to that described in U.S. patent application Ser. No. 17/450,584 filed Oct. 12, 2021, entitled “A Functional-Level Processing Component for Quantum Computers”, which is hereby incorporated by reference in their entirety for all purposes without giving rise to disavowment.

As an example, the quantum circuit may be obtained as a sequence of quantum gates, e.g., quantum gates and their arrangement, that are applied on the plurality of qubits in order to perform computations by manipulating the quantum states of the qubits. As another example, the representation of the quantum circuit may be a DAG. A node in the DAG may represent a quantum function (or a functional block thereof). An edge in the DAG between a first node and a second node of the DAG may represent a qubit that is utilized as an output qubit in a function represented by the first node and as an input qubit in a function represented by the second node. The representation of the quantum circuit may be a representation utilized prior to generating the quantum circuit, such as a compilation representation, a pre-compilation representation, or the like. The representation of the quantum circuit may be provided in a similar manner to that described in U.S. patent application Ser. No. 17/938,347 filed Oct. 6, 2022, entitled “Selecting a Quantum Computer”, which is hereby incorporated by reference in their entirety for all purposes without giving rise to disavowment.

In some exemplary embodiments, the representation of the quantum circuit may comprise a representation of a quantum function configured to be utilized in the quantum circuit. The quantum function may be configured to receive one or more input qubits and perform a manipulation on the one or more input qubits, based on respective values of those qubits. The quantum function defines the specific computations or transformations that are applied to the input qubits.

Additionally or alternatively, the quantum circuit may be obtained after a quantum program or circuit has undergone compilation, transpilation, or the like. The quantum circuit may be obtained in a gate-level quantum circuit, a functional-level quantum circuit, or the like. The quantum circuit may be a circuit that was compiled for a specific target hardware quantum computer, or may be hardware-agnostic. The quantum circuit may be a logical quantum circuit, a physical quantum circuit, or the like.

On Step 120, one or more input conditions on at least a portion of the one or more input qubits may be obtained. In some exemplary embodiments, the one or more input conditions may be conditions that are guaranteed to be met when the quantum function is utilized by the quantum circuit. The conditions may be conditions on the value of the qubits that are provide as inputs to the quantum function at the cycle in which they are provided to the quantum function. Additionally, or alternatively, the one or more input conditions may be determined by a quantum compiler that compiles the quantum program into a gate-level quantum circuit, or based on analysis performed by the quantum compiler, based on insights of the compilation process, or the like. Additionally, or alternatively, the one or more input conditions may be restrictions set by a user, such as a programmer of the respective quantum program of the quantum circuit, a user providing compiling compilation instructions, or the like.

In some exemplary embodiments, the one or more input conditions may comprise an input condition on an input qubit, indicating that a value of the input qubit is a constant. A constant value condition on an input qubit may guarantee a specific constant value for the qubit. As an example, the particular input qubit may be set to a known state, such as |0 [symbol] or |1 [symbol] , or preparing it in a superposition state, like (|0 [symbol] +|1 [symbol] )/√2, or the like, before the quantum function operates on it and does not change it before reaching the cycle in which the quantum function is implemented. As another example, a value of the input qubit may be provided as a parameter by a user.

Additionally, or alternatively, the one or more input conditions may comprise an input condition on an input qubit, indicating that a value of the input qubit is zeros. This input condition is commonly used when the input qubit serves as an auxiliary qubit within the quantum function. An auxiliary qubit is typically utilized to facilitate certain computations or transformations, and setting its value to zero can be part of the desired operation.

In some exemplary embodiments, other types of conditions may be determined, such as entanglement conditions on some qubits, control conditions in functions involving applying controlled quantum operations based on the values of certain control qubits, superposition conditions, or the like.

In some exemplary embodiments, qubit conditions may be determined in a similar manner to that described in U.S. patent application Ser. No. 17/648,691 filed on Jan. 24, 2022 and entitled “Auxiliary Qubits Analysis Based on Partial Compilation of Quantum Programs”, which is hereby incorporated by reference in its entirety for all purposes without giving rise to disavowment.

In some exemplary embodiments, the input conditions affect the behavior and outcome of the quantum function when integrated into the quantum circuit. Under the specific conditions, there may be other alternative quantum functions that are equivalent and will provide the same output as the quantum function.

On Step 125, the quantum circuit may be analyzed to determine pre-conditions that are guaranteed by the quantum circuit with respect to at least a portion of the one or more input qubits. The one or more input conditions may be determined based on the analysis. The one or more input conditions may comprise the determined pre-conditions, conditions derived from the determined pre-conditions, or the like

In some exemplary embodiments, the analysis may be performed in a similar manner to that described in U.S. patent application Ser. No. 18/110,516 filed on Feb. 16, 2023 and entitled “Input-Based Modification of a Quantum Circuit”, which is hereby incorporated by reference in its entirety for all purposes without giving rise to disavowment.

In some exemplary embodiments, the quantum circuit may be analyzed statically to identify patterns that are known to yield identities. Constant input values may be identified and utilized in the static analysis. In other cases, static analysis can be used to identify conditions based on known patterns. Other static analysis methods may be applied.

In some cases, the quantum circuit may be dynamically analyzed by executing or simulating the execution of the quantum circuit. In some cases, by executing the circuit a multiplicity of times, the values and other properties of qubits may be extracted from the execution. For example, quantum tomography may be implemented to reconstruct the quantum value at the cycle in which the quantum function is implemented. Additionally, or alternatively, the quantum circuit may be augmented by introducing a verifying sub-circuit that serves to prove or refute an assumption regarding a condition that is held. A value of a qubit that is outputted by the verifying sub-circuit may be utilized to indicate if the condition is held or not.

Other methods of dynamically or statically analyzing the quantum circuit to identify conditions may be utilized and the disclosed subject matter is not limited to any specific analysis methodology.

Additionally, or alternatively, the one or more input conditions may comprise predetermined input conditions that are obtained from a user, such as a developer, a QA personnel, a user investigating the quantum circuit, or the like.

Additionally, or alternatively, the one or more input conditions may comprise predetermined input conditions that are enforced by the execution platform, or any other entity associated with executing the quantum circuit.

On Step 130, a set of one or more equivalent quantum functions that are equivalent to the quantum function under the one or more input conditions may be determined.

In some exemplary embodiments, set of one or more equivalent quantum functions that are equivalent to the quantum function may be derived directly from the one or more input conditions and the composition of the function (i.e., ignoring a certain parameter in a XOR function when a value thereof is 1). Additionally, or alternatively, equivalent quantum functions that are equivalent to the quantum function under the one or more input conditions may be identified through various strategies, such as analytical approach, which analyze the quantum function and the input conditions mathematically to determine the possible transformations and computations that satisfy the input conditions, circuit manipulation approaches, circuit transformation approaches, simulation, verification, or the like. As an example, known circuit identities, gate decompositions, and circuit rewiring methods, may be applied to determine alternative quantum functions can be obtained. As another example, quantum simulation tools or quantum programming frameworks may be utilized to simulate the behavior of the quantum circuit with the given input conditions.

On Step 135, an equivalences graph representing equivalent functions under various input conditions may be obtained. In some exemplary embodiments, the equivalences graph may be a DAG. In some exemplary embodiments, the equivalences graph may be retained in a data storage and may be prepared in advance. In some cases, the equivalences graph may be retrieved from the data storage based on a query representing the quantum function. If a graph that includes the quantum function exists, the DAG may be returned in response to the query. The set of one or more equivalent quantum functions may be determined based on the equivalences graph.

In some exemplary embodiments, each node of the equivalences graph may represent a function that receives as input an ordered list of qubits (e.g., func(q₁,q₂, . . . ,qₙ)). In some exemplary embodiments, the equivalences graph may comprise unitary nodes that represent unitary functions, and non-unitary nodes that represent non-unitary functions. In the illustration shown in FIG. 2, non-unitary nodes are depicted with a shading, while unitary nodes are depicted without a fill-in color.

Each directed edge of the equivalences graph may be associated with a condition on one qubit of the ordered list of qubits. A directed edge connects between a first node and a second node if under the condition associated with the directed edge an output of the second function is equivalent to an output of the first function. In some cases, the condition is applicable to the function of the first node. For example, the condition may be on a value v of a certain qubit qᵢ. Given the value v, the function of the first node may be logically equivalent to the function of the second node. However, the function of the second node may or may not involve and make any reference to qubit qᵢ. As an example, given the condition qᵢ=v, the qubit qᵢ may be omitted and the result may be the function of the second node.

It may be noted that the equivalences graph may be usable with respect to a plurality of different quantum circuits. The equivalences graph may be generated offline and prior to having access to a specific quantum circuit, may comprise different equivalences between different functions under different conditions, or the like. Additionally, or alternatively, the equivalences graph may be selected from equivalences graphs database storing different preprepared equivalences graphs.

In some exemplary embodiments, equivalences graph may comprise nodes representing equivalent functions determined to be alternative functions with alternative implementations, in a similar manner to that described in U.S. Pat. No. 11,373,114 B1 filed Oct. 12, 2021, entitled “CSP-BASED SYNTHESIS OF A QUANTUM CIRCUIT”, or in U.S. patent application Ser. No. 17/99,082 filed Oct. 12, 2021, entitled “Dynamic Synthesis Of Gate-Level Implementations Of Functional Blocks In Quantum Circuits”, which are hereby incorporated by reference in their entirety for all purposes without giving rise to disavowment.

On Step 140, a set of nodes of the equivalences graph that represent functions that are equivalent to the quantum function in view of the one or more input conditions may be determined.

In some exemplary embodiments, the set of nodes may be obtained by traversing nodes of the equivalences graph, starting from a node representing the quantum function, through directed edges that are associated with conditions that are held by the one or more input conditions (Step 150). In some exemplary embodiments, the set of nodes may include a first set of nodes and a second set of nodes.

On Step 152, a forward cone of influence traversal may be performed over edges that hold the one or more input conditions to determine the first set of nodes. In some exemplary embodiments, the forward cone of influence traversal may start from a node representing the quantum function in equivalences graph in a forward direction (with the edges) to determine the set of nodes that can be influenced by this node, e.g., nodes that represent equivalent functions when the condition represented by the directed edge therebetween holds. It continues recursively, visiting the children's successors, until all reachable nodes have been visited. This traversal captures the entire cone of influence, revealing which nodes are influenced by the starting node.

On Step 154, a backward cone of influence traversal may be performed from the first set of nodes over edges that hold the one or more inputs conditions to determine the second set of nodes. In some exemplary embodiments, the backward cone of influence traversal may be performed from each node in the first or second set in a backward direction to determine the set of nodes that can influence this node, e.g., predecessors or parents that this node is equivalent thereto under a certain condition. accordingly, the backward cone of influence traversal may discover equivalent nodes that may not necessarily be discovered in the forward cone of influence traversal.

In some exemplary embodiments, Steps 152-154 may be repeated until no additional nodes are traversed.

Additionally, or alternatively, forward and backward traversal may be performed in tandem at a same step, so as to add nodes that are reachable using either forward or backward traversal from other traversed nodes.

On Step 160, unitary functions represented by the traversed nodes may be selected to be included in the set of nodes. In some exemplary embodiments, the set of nodes may comprise non-unitary nodes representing non-unitary functions that cannot be implemented using quantum circuits. Accordingly, the set of equivalent quantum functions may exclude such non-unitary function associated with the non-unitary nodes.

In some exemplary embodiments, the first set of nodes may comprise all the nodes that are directly or indirectly affected by the node representing the quantum function, e.g., all the nodes representing equivalent functions. Such functions may also comprise non-unitary functions, represented by non-unitary nodes (e.g., Nodes 240 and 260 in FIG. 2).

A unitary quantum function is a function that can be implemented using a unitary operator, e.g., reversible and does not cause any loss of information. A non-unitary quantum function is a quantum function that cannot be implemented using a unitary operator. Non-unitary quantum functions are not reversible and can cause information loss during computation. These functions may not preserve the norm and inner product of quantum states, which means they are unsuitable to be used in a quantum circuit as they are irreversible operations. Accordingly, such non-unitary functions may cannot be utilized to replace the original quantum function. However, such nodes may be important, as ancestors of such nodes may be potential alternative equivalent functions. The backward cone of influence traversal may provide unitary nodes that are ancestors of the non-unitary nodes.

It may be noted that other representations of the sets of equivalent quantum functions under the one or more input conditions may be utilized, such as rule-based representations, i.e., a set of rules indicating the equivalency between the functions under the one or more condition, mathematical or logical rules, or the like.

On Step 170, an optimized quantum function may be selected from the set of equivalent quantum functions based on a target optimization metric. In some exemplary embodiments, selecting an optimized quantum function from the set of equivalent options may comprise evaluating each function based on the target optimization metric(s) defined by the user, the system, or the like. The evaluation may involve theoretical analysis, simulations, empirical experiments, or the like. By comparing the performance of different functions using the chosen target optimization metric(s), the quantum function that offers the best optimization for the specific goals may be determined.

It may be noted that the selection of an optimized quantum function can be a complex process, as various metrics may have trade-offs and dependencies. Additionally, the specific hardware characteristics and constraints of the quantum platform being used may also influence the selection process. The aim is to find a quantum function that strikes the right balance between different optimization metrics, taking into account the requirements of the quantum computation and the capabilities of the hardware platform.

In some exemplary embodiments, the target optimization metric may be related to a specific objective or goal, such as number of gates, number of cycles, error rates, resources utilizations, quantum volume or the like. The choice of target optimization metric depends on the requirements of the quantum computation being perform and the desired outcomes. As an example, the target optimization metric may be related to gate count, e.g., may aim to minimize the number of quantum gates required to implement the quantum function. Reducing the gate count can lead to shorter execution times and reduce the impact of errors and noise. As another example, the target optimization metric may be related to gate depth, or number of cycles, which measures the total number of time steps or cycles required to execute the quantum circuit implementing the quantum function. Minimizing the gate depth may be important for reducing the overall execution time and mitigating the effects of noise and decoherence. As yet another example, the target optimization metric may be a resource utilization metric, configured to assess the efficient use of quantum resources such as qubits and connectivity. Maximizing the utilization of available resources helps to optimize the overall performance of the quantum circuit. As yet another example, the target optimization metric may be related to error rates. Minimizing error rates may be a critical optimization metric in quantum computing. By selecting a quantum function that is less prone to errors or designing error mitigation strategies, the overall accuracy and reliability of the computation may be improved. As yet another example, the target optimization metric may be based on the ability to execute the quantum circuit on a computer with a fixed quantum volume, such as gate fidelity, coherence times, connectivity, or the like.

In some exemplary embodiments, the target optimization metric may be related to characteristics of the hardware of the quantum execution platform on which the quantum circuit is designated to be executed. Different quantum hardware platforms may have limitations and constraints, such as the available qubit connectivity, gate set, gate error rates, or coherence times. These hardware limitations can impact the choice of the optimized quantum function. As an example, if a particular quantum hardware platform has a limited set of available gate operations or a restricted qubit connectivity pattern, the optimized quantum function may be selected such that it can be efficiently implemented using the supported gates and connectivity. Accordingly, a value of the same target optimization metric may be different for different hardware. This ensures that the quantum circuit can be mapped onto the hardware without excessive overhead or requiring additional resources.

It may be noted that the selection of the optimized quantum function may not always be associated with the number of input qubits of the quantum function. The set of equivalent quantum functions may include different options with varying numbers of input qubits. In some cases, a quantum function with a larger number of input qubits may still be selected as the optimized quantum function, despite having more qubits to initialize and manipulate. The reason for this is that the optimization metric takes into account various aspects and factors beyond just the number of input qubits. The goal may be to find a balance between minimizing the resource requirements and maximizing the efficiency of the quantum computation on the specific hardware platform.

Furthermore, it is noted that the even after the determination of other equivalent alternative quantum functions, in some cases, the original quantum function may be determined to be optimal amongst the possible alternatives and may be retained as is. For example, consider the quantum function of Node 210. After an analysis, and in view of conditions b=0 and c=0 being met, the set of functions of Nodes 210, 220, 230 and 250 may be determined as potential alternatives. Each of the represented functions may be selected as the optimal function for the specific quantum circuit, including the original function of Node 210, and the function of Node 220 which has more qubits than the functions of Nodes 250 and 260. Accordingly, the existence of the non-unitary Node 240 may be of importance as it serves, in this particular example, as the connecting gateway between Nodes 210 and 220. It is also noted that in contradiction to what an engineer with extensive mathematical background may believe, simplification and removal of variables (e.g., qubits), does not always improve the performance and is not always desired.

It may be noted that the previous steps may be performed by the quantum compiler that compiles the quantum program into a gate-level quantum circuit. Additionally, or alternatively, the steps or portion thereof may be performed during different synthesis phases of the quantum circuit, prior to execution of the quantum circuit, or the like.

On Step 180, a modified quantum circuit may be generated by replacing the quantum function with the optimized quantum function. In some exemplary embodiments, the generation of the quantum circuit may be performed by modification of the representation of quantum circuit, that improves the target optimization metric when executing the modified quantum circuit compared to an execution of a different version of the quantum circuit that uses the original function.

In some exemplary embodiments, the modified quantum circuit may be generated based on the original quantum circuit (or other representation thereof, such as a gate-level representation). The modified quantum circuit may be generated by modifying the original quantum circuit, e.g., directly by replacing the quantum function with the optimized quantum function. The modification may improve the target optimization metric when executing the modified quantum circuit compared to an execution of the original quantum circuit.

It may be noted that in some cases if the selected optimized quantum function is the original function, there may be no need to change the quantum circuit, and such modification may be avoided. Additionally, or alternatively, the modification of the quantum circuit may be avoided, such as when the target optimization metric is not improved when executing the modified quantum circuit compared to an execution of the quantum circuit with the original function, or when the improvement is below a predetermined threshold, or the like.

On Step 190, the modified quantum circuit may be executed on a quantum execution platform, such as a quantum computer, a quantum computer simulator, or the like. In some exemplary embodiments, the quantum circuit may be compiled to create an executable circuit that is suitable for execution on the target quantum execution platform.

Referring now to FIG. 2 showing an illustration of an equivalences graph, in accordance with some exemplary embodiments of the subject matter.

In some exemplary embodiments, Subgraph 200 may be a directed acyclic subgraph of an equivalences graph representing equivalent functions under various input conditions. directed edges may be used to connect nodes and represent the conditions associated with the qubits. The equivalences graph or subgraphs thereof, such as Subgraph 200, may illustrate how different functions relate to each other under various input conditions. It may assist in understanding which functions can be interchanged or replaced by others while preserving the desired behavior of the quantum computation.

In some exemplary embodiments, the equivalences graph may be a data structure that graphically represents relationships between different functions acting on qubits. Each node of the equivalences graph may represent a function acting on an ordered list of qubits. The functions may be represented as quantum gates or more complex quantum circuits. As an example, Node 210 represents the function (a, b, c) →(a, b, a+b xor c). As another example, Node 230 represents the function (a, c)→(a, a xor c). It is noted that the naming of the qubits is provided for clarity purposes and may not necessarily be consistent. Instead, each function may be taught of as using an array of qubits, and two functions may be equivalent if there is a suitable mapping between the two functions. For example, Node 230 may be described using q₁, q₂ instead of a and c ((q₁, q₂)→(a₁, q₁ xor q₂)), and the function of Node 210 may be equivalent to that of Node 230 if a is mapped to q₁ and c is mapped to q₂.

Each directed edge may be associated with a condition on at least one qubit of the ordered list of qubits, such that a directed edge connects between a first node and a second node if under the condition associated with the directed edge an output of the second function is equivalent to an output of the first function. This equivalence means that both functions produce the same result, have the same effect on the qubits, provide identical output, within a predetermined error bound, or the like. As an example, Edge 213 is associated with the condition b=0. Edge 213 connects between Node 210 and Node 230 as under the condition b=0 the function (a, b, c) →(a, b, a+b xor c) represented by Node 210 is equivalent to the function (a, c)→(a, a xor c) represented by Node 230. In this exemplary embodiment, each directed edge corresponds to a specific condition on one qubit from the ordered list of qubits, where the condition is in the form of a measurement outcome or a state of the qubit. However, other types of conditions may be associated with edges in other embodiments, such as conditions on a combination of qubits, or the like.

It may be noted that the equivalences graph, utilized to store or calculate information about what functions are equivalent to other functions under various input-conditions, may be generated offline, in advanced, prior to utilization thereof for a specific quantum circuit, or the like. In some cases, the same equivalences graph may be generated once and retrieved and utilized for different quantum circuits. The equivalences graph may be continuously updated and maintained by the system, and may be utilized for different user request.

In some exemplary embodiments, Subgraph 200 may be utilized to identify patterns, simplifications, or optimizations in quantum circuits, explore alternative ways of implementing quantum algorithms, find equivalent circuit structures that may offer advantages in terms of computational efficiency, error correction, or other desired properties, or the like. As an example, function (a, b, c) →(a, b, a+b xor c) represented by Node 210, and function (a, b, c) →(a, b, a+b+c) represented by Node 220, which are different functions that operate on the same set (e.g., list) of qubits, may in some conditions provide the same result. Accordingly, it may be desired to use the implementation of the function represented by Node 220 instead of the function represented by Node 210, such as in cases that the implementation thereof is more efficient in a specific circuit, based on concrete hardware properties, or the like. The analysis of the quantum circuit may begin with the function represented by Node 210, also referred to as the original function, and conditions overs the input qubits are known, Subgraph 200 may be utilized to identify equivalent set of functions of the original function. Under the condition c=0, the function represented by Node 210 and the function represented by Node 220 behave identically. Therefore, the synthesis process may decide to use the function represented by Node 220 instead of the function represented by Node 210, or other functions based on being more efficient, associated with lower error, or the like.

In some exemplary embodiments, Subgraph 200 may be traversed to obtained the set of equivalent quantum functions. The traversal may start from Node 210 representing the original quantum function. The traversal may be performed through directed edges that are associated with conditions that are held by the one or more input conditions. The traversal may comprise a forward cone of influence traversal over edges that hold the relevant input conditions, such as b=0 and c=0. Additionally, or alternatively, the traversal may comprise a backward cone of influence traversal from each node in Subgraph 200 over edges that hold the inputs conditions to determine ancestor nodes that are equivalent to the starting node, such as Node 250 and Node 220. The set of traversed nodes of Subgraph 200 resulted from the forward cone of influence traversal may comprise nodes representing whole-space functions, e.g., unitary functions or functions which may receive an arbitrary input, such as Node 230. Additionally, or alternatively, the set of traversed nodes of Subgraph 200 resulted from the forward cone of influence traversal may comprise nodes representing subspace functions, e.g., non-unitary functions or functions for which we know a property of their input, such as Node 240 and Node 260. Such functions, e.g., (a, b, zeros)→(a, b, a+b) represented by Node 240, or (a, zeros)→(a, a) represented by Node 260, include a concrete value as input (zeros). As such functions are non-unitary, they cannot be utilized in a quantum circuit.

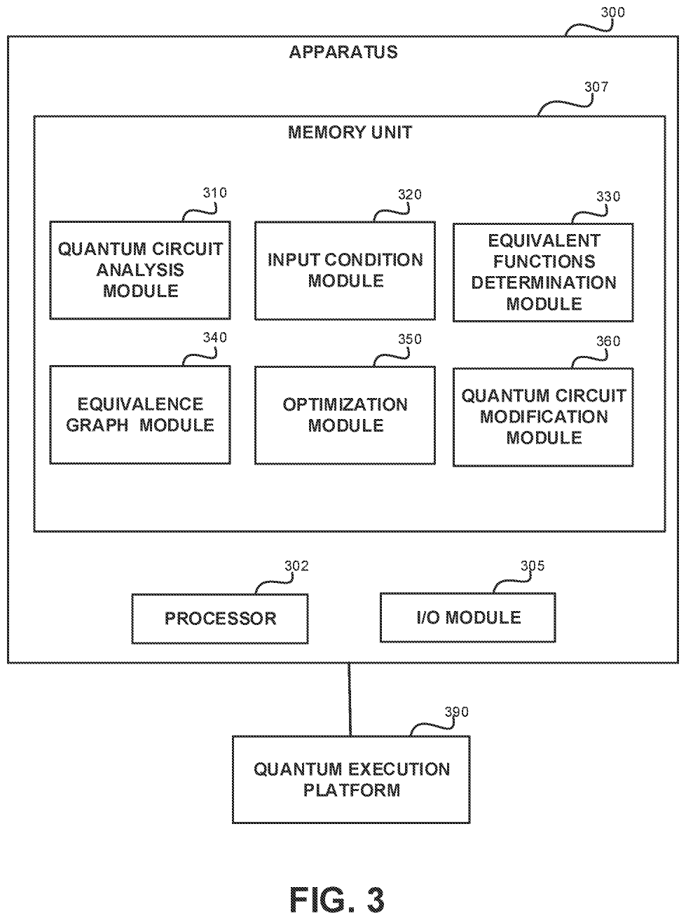

Referring now to FIG. 3 showing a block diagram of an apparatus, in accordance with some exemplary embodiments of the disclosed subject matter.

An Apparatus 300 may be configured to support parallel user interaction with a real-world physical system and a digital representation thereof, in accordance with the disclosed subject matter.

In some exemplary embodiments, Apparatus 300 may comprise one or more Processor(s) 302. Processor 302 may be a Central Processing Unit (CPU), a microprocessor, an electronic circuit, an Integrated Circuit (IC) or the like. Processor 302 may be utilized to perform computations required by Apparatus 300 or any of its subcomponents. It is noted that Processor 302 may be a traditional processor, and not necessarily, a quantum processor.

In some exemplary embodiments of the disclosed subject matter, Apparatus 300 may comprise an Input/Output (I/O) module 305. I/O Module 305 may be utilized to provide an output to and receive input from a user, such as, for example obtaining functions, outputting equivalent quantum circuits, obtain a user-defined quantum program, input conditions on qubits, target optimization metrics, compilation instructions, optimization instructions, selection of an optimization criteria, or the like. Additionally, or alternatively, I/O Module 305 may be utilized to provide output to the user, provide visualization of the quantum program, showing a data structure representing the equivalences graph, or the like. Additionally, or alternatively, I/O Module 305 may be utilized as or in addition to User Interface (UI) module, configured to provide an interface for users to interact with Apparatus 300 or a system associated therewith. I/O Module 305 may be connected to other I/O elements such as displays, input devices (e.g., touchscreens, keyboards), sensors, actuators, databases, or the like.

In some exemplary embodiments, Apparatus 300 may comprise Memory 307. Memory 307 may be a hard disk drive, a Flash disk, a Random-Access Memory (RAM), a memory chip, or the like. In some exemplary embodiments, Memory 307 may retain program code operative to cause Processor 302 to perform acts associated with any of the subcomponents of Apparatus 300. Memory 307 may comprise one or more components as detailed below, implemented as executables, libraries, static libraries, functions, or any other executable components. Additionally, or alternatively, Memory 307 may comprise modules configured to facilitates communication and interaction with a digital representation of a physical system. Memory 307 may be configured to connect to software or databases that store the digital model and provide access to relevant data and functionalities.

Quantum Circuit Analysis Module 310 may be configured to analyze the quantum circuit obtained by the user, or a specific function to be swapped. Quantum Circuit Analysis Module 310 may be configured to analyze manipulation of qubits using quantum gates and performing computations based on the quantum function that are performed by the quantum circuit.

Input Condition Module 320 may be configured to handle and analyze the input conditions specified for the quantum circuit. Input Condition Module 320 may be configured to determine what are the input conditions, and when they are met (e.g., for each quantum function or the like). Additionally, or alternatively, Input Condition Module 320 may be configured to utilize Quantum Circuit Analysis Module 310 in order to analyze the quantum circuit to determine the pre-conditions enforced by the circuit on the input qubits.

Equivalences Graph Module 340 may be configured to generate and maintain the equivalences graph representing equivalent functions under various input conditions. Additionally, or alternatively, Equivalences Graph Module 340 may have an access to an equivalences graph that includes nodes representing functions acting on qubits and directed edges associated with conditions on qubits.

Equivalent Functions Determination Module 330 may be configured to determine sets of equivalent quantum functions based on the input conditions. Equivalent Functions Determination Module 330 may be configured to perform graph traversal algorithms on equivalences graph generated or accessed by Equivalences Graph Module 340. Equivalent Functions Determination Module 330 may be configured to determine for each analyzed function, a set of one or more equivalent quantum functions that are equivalent thereto under the one or more input conditions, wherein said determining is performed using an equivalences graph representing equivalent functions under various input conditions, wherein each node of the equivalences graph represents a function acting on an ordered set of qubits, wherein each directed edge is associated with a condition on one qubit of the ordered set of qubits, wherein a directed edge connects between a first node and a second node if under the condition associated with the directed edge an output of the second function is equivalent to an output of the first function, wherein the equivalences graph comprises at least one unitary node that represents a unitary function, and at least one non-unitary node that represents a non-unitary function, wherein said determining the set of equivalent quantum functions comprises:

Optimization Module 350 may be configured to select an optimized quantum function from the set of equivalent quantum functions based on a target optimization metric. Optimization Module 350 may be configured to consider hardware characteristics of the quantum execution platform designated to execute the circuit, such as Quantum Execution Platform 390. Optimization Module 350 may be configured to select the optimized quantum function to improve the target optimization metric compared to the original quantum function.

Quantum Circuit Modification Module 360 may be configured to modify the quantum circuit by replacing the quantum function with the optimized quantum function. In some exemplary embodiments, Quantum Circuit Modification Module 360 may be configured to perform testing to ensure that the modification improves the target optimization metric.

In some exemplary embodiments, Quantum Circuit Modification Module 360 may be configured to synthesize quantum circuits according while swapping functions in accordance with Optimization Module 350. In some exemplary embodiments, Quantum Circuit Modification Module 360 may be configured to execute the modified quantum circuits onto Quantum Execution Platform 390, or any other execution platform, to be executed thereby. In some exemplary embodiments, Quantum Circuit Modification Module 360 may simulate execution of the quantum circuit using an emulator, a simulator, or the like, on a classic computer, instead of actual execution by Quantum Execution Platform 390.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
obtaining a representation of a quantum circuit, the quantum circuit manipulates a plurality of qubits over a plurality of cycles using a plurality of quantum gates, the representation of the quantum circuit comprises a representation of a quantum function configured to be utilized in the quantum circuit, wherein the quantum function is configured to receive one or more input qubits and perform a manipulation on the one or more input qubits;
obtaining one or more input conditions on at least a portion of the one or more input qubits, the one or more input conditions are guaranteed to be met when the quantum function is utilized by the quantum circuit;
determining a set of one or more equivalent quantum functions that are equivalent to the quantum function under the one or more input conditions, wherein said determining is performed using an equivalences graph representing equivalent functions under various input conditions, wherein each node of the equivalences graph represents a function acting on an ordered list of qubits, wherein each directed edge is associated with a condition on one qubit of the ordered list of qubits, wherein a directed edge connects between a first node and a second node if under the condition associated with the directed edge an output of the second function is equivalent to an output of the first function, wherein the equivalences graph comprises at least one unitary node that represents a unitary function, and at least one non-unitary node that represents a non-unitary function, wherein said determining the set of equivalent quantum functions comprises:
determining a set of nodes of the equivalences graph that represent functions that are equivalent to the quantum function in view of the one or more input conditions, wherein said determining the set of nodes comprises traversing nodes, starting from a node representing the quantum function, through directed edges that are associated with conditions that are held by the one or more input conditions; and
wherein the set of equivalent quantum functions comprises unitary functions included in the set of nodes;
selecting an optimized quantum function from the set of equivalent quantum functions, wherein said selecting is performed based on a target optimization metric; and
generating a modified quantum circuit by replacing the quantum function with the optimized quantum function, whereby improving the target optimization metric when executing the modified quantum circuit compared to an execution of a different version of quantum circuit that uses the quantum function.

2. The method of claim 1, wherein the set of nodes comprises a non-unitary node, wherein the set of equivalent quantum functions excludes the non-unitary function associated with the non-unitary node.

3. The method of claim 1, wherein said determining the set of nodes comprises:
a forward cone of influence traversal over edges that hold the one or more input conditions to determine a first set of nodes; and
a backward cone of influence traversal from the first set of nodes over edges that hold the one or more inputs conditions to determine a second set of nodes;
wherein the set of nodes include the first set of nodes and the second set of nodes.

4. The method of claim 3, wherein the first set of nodes comprises a non-unitary node, wherein the second set of nodes comprises a unitary node that is an ancestor of the non-unitary node, wherein the unitary node is included in the second set of nodes based on a connection between the non-unitary node and the unitary node.

5. The method of claim 1, wherein the set of equivalent quantum functions includes the quantum function, whereby said selecting the optimized quantum function enables selecting to avoid modifying the quantum circuit.

6. The method of claim 1, wherein the set of equivalent quantum functions include a first quantum function and a second quantum function having a first set of input qubits and a second set of input qubits respectively, a number of qubits in the first set of input qubits is smaller than a number of qubits in the second set of input qubits, wherein the second quantum function is selected as the optimized quantum function in spite of having a larger number of input qubits.

7. The method of claim 1, wherein said obtaining the one or more input conditions comprises analyzing the representation of the quantum circuit to determine pre-conditions that are enforced by the quantum circuit over at least a portion of the one or more input qubits.

8. The method of claim 1 further comprises generating the equivalences graph, wherein said generating is performed offline and prior to having access to the representation of the quantum circuit, whereby the equivalences graph is usable with respect to a plurality of different quantum circuits.

9. The method of claim 1 further comprises executing the modified quantum circuit on a quantum execution platform.

10. The method of claim 1, wherein said selecting the optimized quantum function is performed based on hardware characteristics of a quantum execution platform that is designated to execute the quantum circuit.

11. The method of claim 1, wherein the one or more input conditions on at least a portion of the one or more input qubits comprises an input condition on an input qubit, the input condition indicating that a value of the input qubit is constant.

12. The method of claim 1, wherein the one or more input conditions on at least a portion of the one or more input qubits comprises an input condition on an input qubit, the input condition indicating that a value of the input qubit is zeros, wherein the input qubit is utilized in the quantum function as an auxiliary qubit.

13. The method of claim 1, wherein the representation of the quantum circuit is a quantum program provided programmed in a high-level programming language, wherein the quantum program defines quantum functions used in the quantum circuit, partial order therebetween, and information passing between the quantum functions.

14. The method of claim 13, wherein said obtaining the one or more input conditions and said selecting the optimized quantum function are performed by a quantum compiler that compiles the quantum program into a gate-level quantum circuit.

15. The method of claim 13, wherein the one or more input conditions are derived from the quantum program or instructions provided with the quantum program, whereby the quantum program or the instruction provided therewith guarantee that the one or more input conditions are met when the quantum function is utilized by the quantum circuit.

16. The method of claim 1,
wherein the representation of the quantum circuit is a Directed Acyclic Graph (DAG), a node in the DAG represents a quantum function, wherein an edge in the DAG between a first node and a second node of the DAG represents a qubit that is utilized as an output qubit in a function represented by the first node and as an input qubit in a function represented by the second node.

17. The method of claim 1, wherein the set of equivalent quantum functions consists of all unitary functions included in the set of nodes.

18. A method for modifying a quantum circuit, comprising:
obtaining the quantum circuit, the quantum circuit manipulates a plurality of qubits over a plurality of cycles using a plurality of quantum gates, the quantum circuit comprises a quantum function, wherein the quantum function is configured to receive one or more input qubits and perform a manipulation on the one or more input qubits;
obtaining one or more input conditions on at least a portion of the one or more input qubits, the one or more input conditions are guaranteed to be met when the quantum function is utilized by the quantum circuit;
determining a set of one or more equivalent quantum functions that are equivalent to the quantum function under the one or more input conditions, wherein said determining is performed using an equivalences graph representing equivalent functions under various input conditions, wherein each node of the equivalences graph represents a function acting on an ordered list of qubits, wherein each directed edge is associated with a condition on one qubit of the ordered list of qubits, wherein a directed edge connects between a first node and a second node if under the condition associated with the directed edge an output of the second function is equivalent to an output of the first function, wherein the equivalences graph comprises at least one unitary node that represents a unitary function, and at least one non-unitary node that represents a non-unitary function, wherein said determining the set of equivalent quantum functions comprises:
determining a set of nodes of the equivalences graph that represent functions that are equivalent to the quantum function in view of the one or more input conditions, wherein said determining the set of nodes comprises traversing nodes, starting from a node representing the quantum function, through directed edges that are associated with conditions that are held by the one or more input conditions; and
wherein the set of equivalent quantum functions comprises unitary functions included in the set of nodes;
selecting an optimized quantum function from the set of equivalent quantum functions, wherein said selecting is performed based on a target optimization metric; and
modifying the quantum circuit by replacing the quantum function with the optimized quantum function, whereby improving the target optimization metric when executing the modified quantum circuit compared to an execution of the quantum circuit.

19. The method of claim 18, wherein the quantum circuit is a pre-existing quantum circuit that was synthesized by a compiler.

20. A computerized apparatus having a processor, the processor being adapted to perform the steps of:
obtaining a representation of a quantum circuit, the quantum circuit manipulates a plurality of qubits over a plurality of cycles using a plurality of quantum gates, the representation of the quantum circuit comprises a representation of a quantum function configured to be utilized in the quantum circuit, wherein the quantum function is configured to receive one or more input qubits and perform a manipulation on the one or more input qubits;
obtaining one or more input conditions on at least a portion of the one or more input qubits, the one or more input conditions are guaranteed to be met when the quantum function is utilized by the quantum circuit;
determining a set of one or more equivalent quantum functions that are equivalent to the quantum function under the one or more input conditions, wherein said determining is performed using an equivalences graph representing equivalent functions under various input conditions, wherein each node of the equivalences graph represents a function acting on an ordered list of qubits, wherein each directed edge is associated with a condition on one qubit of the ordered list of qubits, wherein a directed edge connects between a first node and a second node if under the condition associated with the directed edge an output of the second function is equivalent to an output of the first function, wherein the equivalences graph comprises at least one unitary node that represents a unitary function, and at least one non-unitary node that represents a non-unitary function, wherein said determining the set of equivalent quantum functions comprises:
determining a set of nodes of the equivalences graph that represent functions that are equivalent to the quantum function in view of the one or more input conditions, wherein said determining the set of nodes comprises traversing nodes, starting from a node representing the quantum function, through directed edges that are associated with conditions that are held by the one or more input conditions; and
wherein the set of equivalent quantum functions comprises unitary functions included in the set of nodes;
selecting an optimized quantum function from the set of equivalent quantum functions, wherein said selecting is performed based on a target optimization metric; and
generating a modified quantum circuit by replacing the quantum function with the optimized quantum function, whereby improving the target optimization metric when executing the modified quantum circuit compared to an execution of a different version of quantum circuit that uses the quantum function.

21. A computer program product comprising a non-transitory computer readable storage medium retaining program instruction, which program instructions when read by a processor, cause the processor to perform a method comprising:
obtaining a representation of a quantum circuit, the quantum circuit manipulates a plurality of qubits over a plurality of cycles using a plurality of quantum gates, the representation of the quantum circuit comprises a representation of a quantum function configured to be utilized in the quantum circuit, wherein the quantum function is configured to receive one or more input qubits and perform a manipulation on the one or more input qubits;
obtaining one or more input conditions on at least a portion of the one or more input qubits, the one or more input conditions are guaranteed to be met when the quantum function is utilized by the quantum circuit;
determining a set of one or more equivalent quantum functions that are equivalent to the quantum function under the one or more input conditions, wherein said determining is performed using an equivalences graph representing equivalent functions under various input conditions, wherein each node of the equivalences graph represents a function acting on an ordered list of qubits, wherein each directed edge is associated with a condition on one qubit of the ordered list of qubits, wherein a directed edge connects between a first node and a second node if under the condition associated with the directed edge an output of the second function is equivalent to an output of the first function, wherein the equivalences graph comprises at least one unitary node that represents a unitary function, and at least one non-unitary node that represents a non-unitary function, wherein said determining the set of equivalent quantum functions comprises:
determining a set of nodes of the equivalences graph that represent functions that are equivalent to the quantum function in view of the one or more input conditions, wherein said determining the set of nodes comprises traversing nodes, starting from a node representing the quantum function, through directed edges that are associated with conditions that are held by the one or more input conditions; and
wherein the set of equivalent quantum functions comprises unitary functions included in the set of nodes;
selecting an optimized quantum function from the set of equivalent quantum functions, wherein said selecting is performed based on a target optimization metric; and
generating a modified quantum circuit by replacing the quantum function with the optimized quantum function, whereby improving the target optimization metric when executing the modified quantum circuit compared to an execution of a different version of quantum circuit that uses the quantum function.

22. A computerized apparatus having a processor, the processor being adapted to perform the steps of:
obtaining the quantum circuit, the quantum circuit manipulates a plurality of qubits over a plurality of cycles using a plurality of quantum gates, the quantum circuit comprises a quantum function, wherein the quantum function is configured to receive one or more input qubits and perform a manipulation on the one or more input qubits;
obtaining one or more input conditions on at least a portion of the one or more input qubits, the one or more input conditions are guaranteed to be met when the quantum function is utilized by the quantum circuit;
determining a set of one or more equivalent quantum functions that are equivalent to the quantum function under the one or more input conditions, wherein said determining is performed using an equivalences graph representing equivalent functions under various input conditions, wherein each node of the equivalences graph represents a function acting on an ordered list of qubits, wherein each directed edge is associated with a condition on one qubit of the ordered list of qubits, wherein a directed edge connects between a first node and a second node if under the condition associated with the directed edge an output of the second function is equivalent to an output of the first function, wherein the equivalences graph comprises at least one unitary node that represents a unitary function, and at least one non-unitary node that represents a non-unitary function, wherein said determining the set of equivalent quantum functions comprises:
determining a set of nodes of the equivalences graph that represent functions that are equivalent to the quantum function in view of the one or more input conditions, wherein said determining the set of nodes comprises traversing nodes, starting from a node representing the quantum function, through directed edges that are associated with conditions that are held by the one or more input conditions; and
wherein the set of equivalent quantum functions comprises unitary functions included in the set of nodes;
selecting an optimized quantum function from the set of equivalent quantum functions, wherein said selecting is performed based on a target optimization metric; and
modifying the quantum circuit by replacing the quantum function with the optimized quantum function, whereby improving the target optimization metric when executing the modified quantum circuit compared to an execution of the quantum circuit.

23. A computer program product comprising a non-transitory computer readable storage medium retaining program instruction, which program instructions when read by a processor, cause the processor to perform a method comprising:
obtaining the quantum circuit, the quantum circuit manipulates a plurality of qubits over a plurality of cycles using a plurality of quantum gates, the quantum circuit comprises a quantum function, wherein the quantum function is configured to receive one or more input qubits and perform a manipulation on the one or more input qubits;
obtaining one or more input conditions on at least a portion of the one or more input qubits, the one or more input conditions are guaranteed to be met when the quantum function is utilized by the quantum circuit;
determining a set of one or more equivalent quantum functions that are equivalent to the quantum function under the one or more input conditions, wherein said determining is performed using an equivalences graph representing equivalent functions under various input conditions, wherein each node of the equivalences graph represents a function acting on an ordered list of qubits, wherein each directed edge is associated with a condition on one qubit of the ordered list of qubits, wherein a directed edge connects between a first node and a second node if under the condition associated with the directed edge an output of the second function is equivalent to an output of the first function, wherein the equivalences graph comprises at least one unitary node that represents a unitary function, and at least one non-unitary node that represents a non-unitary function, wherein said determining the set of equivalent quantum functions comprises:
determining a set of nodes of the equivalences graph that represent functions that are equivalent to the quantum function in view of the one or more input conditions, wherein said determining the set of nodes comprises traversing nodes, starting from a node representing the quantum function, through directed edges that are associated with conditions that are held by the one or more input conditions; and
wherein the set of equivalent quantum functions comprises unitary functions included in the set of nodes;
selecting an optimized quantum function from the set of equivalent quantum functions, wherein said selecting is performed based on a target optimization metric; and
modifying the quantum circuit by replacing the quantum function with the optimized quantum function, whereby improving the target optimization metric when executing the modified quantum circuit compared to an execution of the quantum circuit.
